(19) United States
(12) Patent Application Publication
(10) Pub. No.: US 2024/0183978 A1
(43) Pub. Date: Jun. 6, 2024

(54) CHIRP-BASED ULTRASONIC SENSOR AND SIGNAL PROCESSING METHOD

(71) Applicant: HYUNDAI MOBIS CO., LTD., Seoul (KR)

(72) Inventor: Jae Young LEE, Icheon-si (KR)

(73) Assignee: HYUNDAI MOBIS CO., LTD., Seoul (KR)

(21) Appl. No.: 18/494,968

(22) Filed: Oct. 26, 2023

(30) Foreign Application Priority Data
Dec. 5, 2022 (KR) 10-2022-0167971

(51) Int. Cl. G01S 15/10; G01S 7/526

(52) U.S. Cl. CPC G01S 15/10; G01S 7/526

(57) ABSTRACT

Provided are a chirp-based ultrasonic sensor and a signal processing method. In more detail, the ultrasonic sensor which measures a distance to an object positioned in front includes: a transmitter outputting an ultrasonic signal; a receiver receiving a wave reflected from the output ultrasonic signal; and a signal processor providing an ultrasonic signal command to be output to the transmitter, and calculating the distance to the object by using the reflected wave received by the receiver, wherein the signal processor controls the transmitter for the transmitter to transmit a pulse train whose frequency is changed based on time.

### CROSS-REFERENCE TO RELATED APPLICATIONS

This application claims priority under 35 U.S.C. § 119 to Korean Patent Application No. 10-2022-0167971, filed on Dec. 5, 2022, in the Korean Intellectual Property Office, the disclosure of which is incorporated herein by reference in its entirety.

### TECHNICAL FIELD

The following disclosure relates to a chirp-based ultrasonic sensor and a signal processing method.

### BACKGROUND

An ultrasonic sensor for a vehicle or other moving object can sense obstacles in the vehicle's path. The ultrasonic sensor may distinguish between the ground surface and an obstacle by a magnitude of a reflected wave. That is, the ultrasonic sensor may determine that a corresponding signal is reflected from the obstacle when the magnitude of the reflected wave is greater than a predetermined threshold value, and determine that the corresponding signal is reflected from the ground when the magnitude of the reflected wave is less than the predetermined threshold value. In order to have a lower misrecognition probability, the ultrasonic sensor may acquire ground waveforms based on time on roads having various road surfaces as shown in FIG. 1, extract the maximum value of the acquired waveforms, and add a margin to thus determine the threshold value.

In general, the ultrasonic sensor for a vehicle may use a physical wave, and thus be vulnerable to an environmental change. Therefore, the ultrasonic sensor may set the threshold value based on the maximum ground waveform generated on a Belgian road or a gravel road to be operated effectively against the environmental change. Accordingly, a high threshold value may lower a false alarm probability. However, the ultrasonic sensor may also have a shorter detection distance because an ultrasonic signal reflected from the obstacle is lower at a greater distance. In recent years, an autonomous parking controller requires a large detection region to search for a parking space and mitigate possible collision with a pedestrian. However, the ultrasonic sensor may be designed to have a wide vertical beam angle to detect a nearby road bump, and the ground waveform may thus be positioned at the center of a beam pattern as shown in FIG. 2 in a long-distance region. Here, the ultrasonic sensor may have a limit to increasing its detection distance because the ground waveform received from the Belgian road or the gravel road is larger than an object reflection wave.

### RELATED ART DOCUMENT

Korean Patent Laid-Open Publication No. 10-2022-0086391 (published on Jun. 23, 2022)

### SUMMARY

An embodiment of the present disclosure is directed to providing a chirp-based ultrasonic sensor for moving objects which may detect a near field, a medium distance, or a far field, and a signal processing method.

In one general aspect, an ultrasonic sensor which measures a distance to an object positioned in front includes: a transmitter outputting an ultrasonic signal; a receiver receiving a wave reflected from the output ultrasonic signal; and a signal processor providing an ultrasonic signal command to be output to the transmitter, and calculating the distance to the object by using the reflected wave received by the receiver, wherein the signal processor controls the transmitter for the transmitter to transmit a pulse train whose frequency is changed based on time.

The signal processor may calculate each distance to the object positioned in each of a plurality of predetermined regions.

The signal processor may calculate each distance to the object positioned in at least one of a near field, a medium distance, or a far field.

The signal processor may include a first band pass filter (BPF) passing only the reflected wave in a predetermined frequency band, and the first BPF performs filtering by changing a frequency band to be filtered by the first BPF based on reception time of the reflected wave.

The signal processor may pass only a frequency in a range of 40 kHz or more and less than 48 kHz in a region where the reception time of the reflected wave is zero or more and less than T₁, only a frequency in a range of 48 kHz or more and 60 kHz or less in a region of T₁ or more and T₂ or less, and a frequency in a range of 40 kHz or more and 60 kHz or less in a region exceeding T₂.

The signal processor may transmit intermittent pulse group signals of the pulse train, and control each of the pulse groups to be changed to a frequency band of a region of 40 kHz or more and 60 kHz or less based on the time.

The signal processor may include a signal generator generating a cross-correlation signal by cross-correlate the ultrasonic signal and the reflected wave.

The signal processor may further include a second band pass filter (BPF) passing only the ultrasonic signal in a predetermined frequency band, and the predetermined frequency band may be the same as a frequency band of the reflected wave.

The signal processor may further include a time of flight (TOF) compensator calculating a TOF compensation value based on Δt, which is a difference between a time when a specific frequency occurs in the ultrasonic signal and a time when the specific frequency is measured in the reflected wave, and performing TOF compensation on the cross-correlation signal.

In another general aspect, a signal processing method of an ultrasonic sensor which includes a transmitter, a receiver, and a signal processor, includes: (a) controlling the transmitter by the signal processor for the transmitter to transmit a pulse train whose frequency is changed based on time; and (b) calculating, by the signal processor, each distance to an object positioned in each of a plurality of predetermined regions by using a reflected wave received from the receiver.

The method may further include (a-1) determining whether signal processing by the ultrasonic sensor is required for the reflected wave based on a predetermined determination criterion after the operation (a) and before the operation (b).

In the operation (a-1), when t indicates reception time of receiving the reflected wave, it may be determined that the signal processing by the ultrasonic sensor is required in a case where t is less than a predetermined maximum reception time, and it may be determined that the signal processing by the ultrasonic sensor is not required when t is greater than the predetermined maximum reception time.

In the operation (b), each distance to the object positioned in at least one of a near field, a medium distance, or a far field may be calculated.

The operation (b) may include: (b-1) performing filtering by passing only the reflected wave in a predetermined frequency band and changing a frequency band to be filtered by a band pass filter (BPF) based on reception time of the reflected wave; and (b-2) filtering the pulse train in the same frequency band as that of the reflected wave.

In the operation (b-1), only a frequency in a range of 40 kHz or more and less than 48 kHz may pass in a region where the reception time of the reflected wave is zero or more and less than T₁, only a frequency in a range of 48 KHz or more and 60 kHz or less may pass in a region of T₁ or more and T₂ or less, and a frequency in a range of 40 kHz or more and 60 kHz or less may pass in a region exceeding Ta.

In the operation (a), intermittent pulse group signals of the pulse train may be transmitted, and each of the pulse groups may be controlled to be transmitted by being changed to the frequency band of 40 kMz or more and 60 KMz or less based on the time.

The operation (b) may further include (b-3) generating a cross-correlation signal by cross-correlating the filtered pulse train and the reflected wave after the operation (b-2).

The operation (b) may further include (b-4) calculating a time of flight (TOF) compensation value based on Δt, which is a difference between a time when a specific frequency occurs in the pulse train and a time when the specific frequency is measured in the reflected wave, and performing TOF compensation on the cross-correlation signal, after the operation (b-3).

### BRIEF DESCRIPTION OF THE DRAWINGS

FIG. 1 is a graph showing a magnitude of a reflection waveform and a threshold value based on the time of a conventional ultrasonic sensor for moving objects.

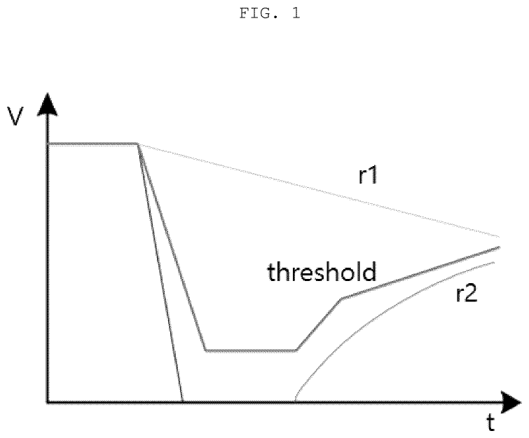

FIG. 2 is a view showing a high ground wave generation path of a conventional far-field ultrasonic sensor.

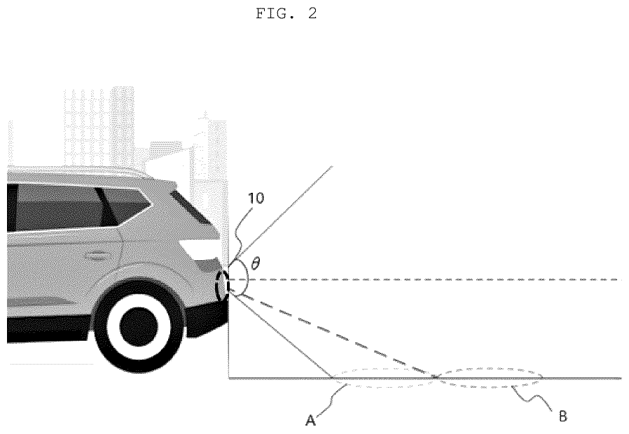

FIG. 3 is a block diagram showing an ultrasonic sensor according to an embodiment of the present disclosure.

FIGS. 4A and 4B are graphs each showing one pulse of a pulse train and a correlation result between the pulse train and a reflected wave according to an embodiment of the present disclosure.

FIGS. 5A and 5B are simulation graphs showing a vertical beam angle of a general chirp signal and a vertical beam angle of a chirp signal within a range of 40 kHz to 60 kHz according to the present disclosure.

FIG. 6 is a flowchart showing a signal processing method of an ultrasonic sensor according to another embodiment of the present disclosure.

FIG. 7 is a flowchart showing a signal processing operation in another implementation example of another embodiment of the present disclosure.

### DETAILED DESCRIPTION

In order to describe the present disclosure, operational advantages of the present disclosure, and objects accomplished by embodiments of the present disclosure, the embodiments of the present disclosure are hereinafter exemplified and described with reference to the accompanying drawings.

First, terms used in the specification are used only to describe the specific embodiments rather than limiting the present disclosure, and a term of a singular number may include its plural number unless explicitly indicated otherwise in the context. In addition, it is to be understood that a term “include,” “formed of.” or the like used in this application specifies the existence of features, numerals, operations, operations, components, parts or combinations thereof, which are mentioned in the specification, and does not preclude the existence or addition of one or more other features, numerals, steps, operations, components, parts, or combinations thereof.

When it is decided that the detailed description of the known configuration or function related to the present disclosure may obscure the gist of the present disclosure, the detailed description thereof will be omitted.

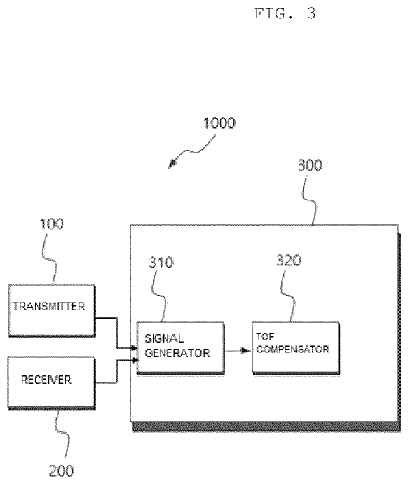

FIG. 3 is a block diagram showing an ultrasonic sensor according to an embodiment of the present disclosure.

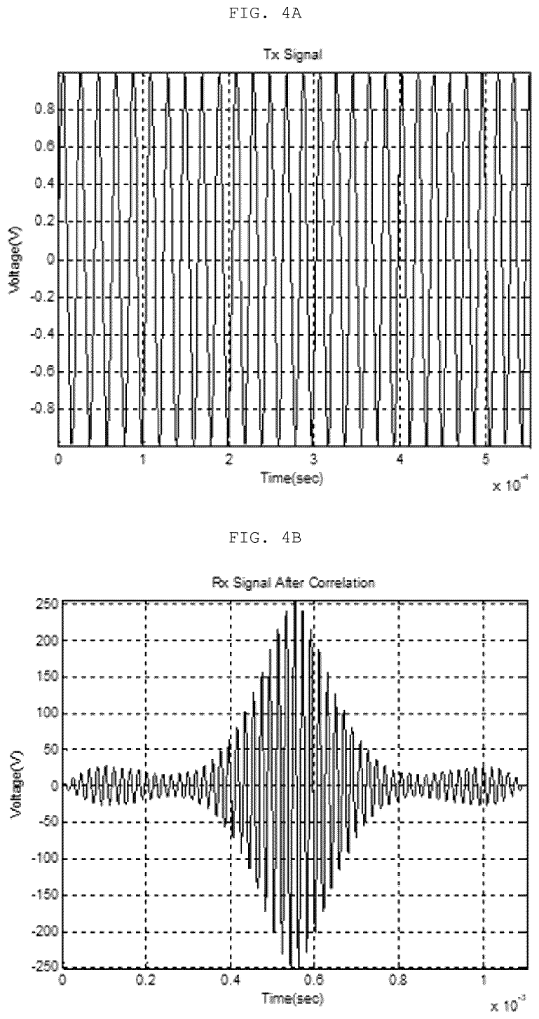

FIGS. 4A and 4B are graphs each showing one pulse of a pulse train and a correlation result between the pulse train and a reflected wave according to an embodiment of the present disclosure.

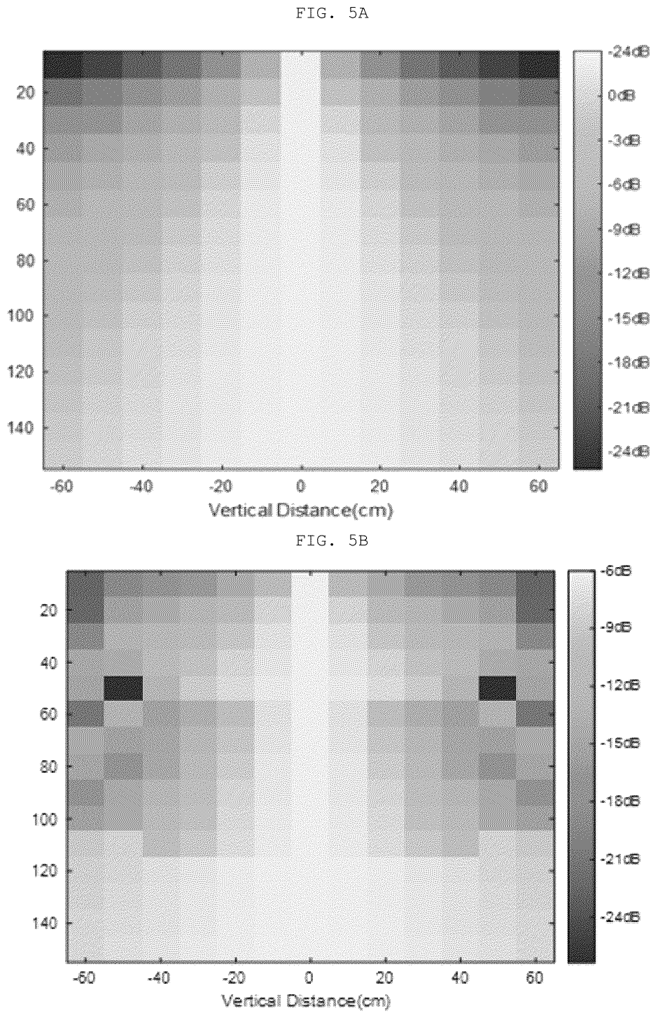

FIGS. 5A and 5B are simulation graphs showing a vertical beam angle of a chirp signal within a range of 40 kHz to 60 kHz according to the present disclosure.

The description describes a signal processing device of the ultrasonic sensor according to an embodiment of the present disclosure with reference to FIGS. 3 to 5.

First, referring to FIG. 3, the present disclosure relates to an ultrasonic sensor 1000 which measures a distance to an object positioned in front, and the ultrasonic sensor 1000 may include a transmitter 100, a receiver 200, and a signal processor 300.

In detail, the ultrasonic sensor 1000 may be positioned on a moving object, such as a vehicle, and recognize at least one of an object positioned in front or behind the moving object or an object positioned on the ground.

The transmitter 100 may transmit an ultrasonic signal.

The receiver 200 may receive a wave reflected from the ultrasonic signal transmitted by the transmitter 100.

The signal processor 300 may provide an ultrasonic signal command to be output to the transmitter 100 and calculate the distance to the object based on the reflected wave received by the receiver 200.

In detail, the signal processor 300 may control the transmitter 100 so that the transmitter 100 transmits a pulse train changed based on time.

In addition, the signal processor 300 may calculate each distance to the object positioned in each of a plurality of predetermined regions and calculate the distance to the object positioned in at least one of a near field, a medium distance, or a far field based on the reception time and frequency band of the reflected wave.

Meanwhile, the pulse train may be a transmission chirp signal. In addition, the reflected wave may be a received chirp signal.

In more detail, the signal processor 300 may transmit intermittent pulse group signals of the pulse train and control each of the pulse groups to be changed to the frequency band of 40 kMz or more and 60 kMz or less based on the time.

In addition, the signal processor 300 may include a signal generator 310.

The signal generator 310 may generate a cross-correlation signal by cross-correlating the ultrasonic signal (or the pulse train) and the reflected wave.

Hereinafter, the description describes a pulse compression method of a chirp-based ultrasonic signal.

In general, a signal used in the ultrasonic sensor 1000 for moving objects may be expressed as a trigonometric function having f₀ which is a center frequency. S_{c}(t), which is the transmission chirp signal whose frequency is changed from the center frequency to

f₀−Δf/2˜f₀+Δt/2

during a period T, may be expressed as Equation 1 below:

$$\\ \begin{matrix}{s}_{c} ( t ) = \{ \begin{matrix}{Ae}^{{}_{} j 2 π ( ( {f}_{0} - \frac{Δ f}{2} ) t + \frac{Δ f}{T} {t}^{{}_{} 2} )} , & if 0 \leq t \leq T \\ 0 , & otherwise\end{matrix} . & [ Equation 1 ]\end{matrix}$$

r_{c}(t), which is the received chirp signal of the ultrasonic sensor 1000, may pass through a sensor cell when the signal is transmitted and received, which may thus be expressed as Equation 2 below:

$$\\ \begin{matrix}{r}_{c} ( t ) = {s}_{c} ( t - \frac{2 R}{c} ) * s ( t ) * s ( t ) . & [ Equation 2 ]\end{matrix}$$

In Equation 2, s(t) indicates an impulse response of the ultrasonic sensor 1000, R indicates a position of the object, c indicates an ultrasonic velocity, and * indicates a convolution computation.

Here, S_{c}(t) and r_{c}(t) may be cross-correlated in order to compress a pulse of the received chirp signal, which may be expressed as Equation 3 below:

$$\\ \begin{matrix}〈 {s}_{c} , {r}_{c} 〉 ( t ) = {A}^{{}_{} 2} T Λ ( \frac{t - 2 R / c}{T} ) sin c [ π Δ f ( t - \frac{2 R}{c} ) Λ ( \frac{t - 2 R / c}{T} ) ] {e}^{{}_{} j 2 π {f}_{0} t} * s ( t ) * s ( t ) . & [ Equation 3 ]\end{matrix}$$

In Equation 3 above, Λ(t) indicates a triangular function. Therefore, an amplitude of a cross-correlation result signal may be increased from A to A²T, and an object positioned further away may thus be detected when using the pulse compression method. Here, a magnitude of noise may not be amplified by a cross-correlation relationship.

Therefore, the transmission chirp signal of one pulse is shown in FIG. 4A, and a result of correlation between the transmission chirp signal and the received chirp signal (not shown) is shown in FIG. 4B. Referring to FIGS. 4A and 4B, the ultrasonic sensor 1000 may have an increased detection distance by acquiring the same result as a result of transmitting a transmission signal having an amplitude of 250 by using a transmission signal having an amplitude of 1.

It may be advantageous for the ultrasonic sensor 1000 for moving objects to detect the object because the sensor effectively detects a road bump having a bumper height or higher as the beam angle is larger in the near field, and the sensor has a smaller ground reflection wave as the beam angle is smaller in the medium distance.

Therefore, based on the above information, the description describes the signal processing device of the present disclosure which may calculate the distance to an object positioned in the near field, the medium distance, or the far field by changing the band of the chirp signal used for the pulse compression based on the distance.

Distribution of ultrasonic pressure in a far-field region may be expressed as Equation 4 below according to Rayleigh Sommerfeld scalar diffraction theory. Therefore, the beam angle may be changed based on the frequency f₀:

$$\\ \begin{matrix}p ( x , z ) = \frac{B}{z} X ( \frac{{f}_{o} x}{cz} ) where X ( f ) = \frac{1}{2 π} \int x ( t ) {e}^{- j 2 π ft} dt . & [ Equation 4 ]\end{matrix}$$

In Equation 4 above, p indicates the ultrasonic pressure, c indicates the ultrasonic velocity (i.e., 340 m/s), and x and z indicate distance coordinates. In addition, B indicates a constant, and X(f) indicates a Fourier transform.

Therefore, when the chirp signal uses the band of 40 kMz or more and 60 kMz or less, a pass band of a band pass filter (BPF) may be changed based on a signal-reception time point. Accordingly, the signal processor 300 may include a first BPF passing only the reflected wave in a predetermined frequency band.

In other words, the first BPF may perform filtering by changing a frequency band to be filtered based on reception time of the reflected wave.

In detail, a time region of zero or more and less than T₁ may correspond to the near-field region of less than 60 cm, which requires a large beam angle to detect the road bump. Therefore, the first BPF may use a low frequency band in the region corresponding to T₁.

The T₁ may be 3.5 ms, and the low frequency band may be 40 kHz or more and less than 48 KHz.

In addition, a time region of T₁ or more and T₂ or less may correspond to a medium-distance region of 60 cm or more and 120 cm or less, which requires a small beam angle to distinguish the ground waveform from an obstacle. Therefore, the first BPF may use a high frequency band in the region corresponding to T₂.

The T₂ may be 7 ms, and the high frequency band may be 48 KHz or more and 60 kHz or less.

In addition, a region exceeding T₂ may correspond to the far-field region exceeding 120 cm, which requires an entire frequency band to detect a small reflected wave. Therefore, the first BPF may use the entire frequency band in the region corresponding to T₃.

The entire frequency band may be 40 kHz or more and 60 kHz or less.

As a result, when the beam angle is changed based on the time (or the distance) as described above, the large beam angle may be provided because the result of transmitting and receiving a signal of the low frequency is processed in the near field, and the small beam angle may be provided by using the high frequency band in the medium distance. In addition, the ground region may be already included in the beam angle in the far field, and the detection distance may thus be increased by even a small reflected wave detected using the entire signal band.

Similar to filtering the reflected wave, the ultrasonic signal (or the pulse train) may be filtered.

Accordingly, the signal processor 300 may further include a second BPF passing only the ultrasonic signal (or the pulse train) in a predetermined frequency band.

The second BPF may perform the filtering in the same frequency band as the filtered frequency band of the reflected wave.

For example, a parasitic frequency component may occur when the signal generator 310 generates the cross-correlation signal in a case where the frequency band of the pulse train transmitted by the transmitter 100 is 40 kHz or more and 60 kHz or less and a frequency band of the filtered reflected wave is 40 kHz or more and less than 48 KHz.

Accordingly, the second BPF may perform the filtering in the same frequency band as the first BPF to thus amplify the signal by the pulse compression.

Meanwhile, when the transmission chirp signal has the same value as that acquired by Equation 1 above, a signal of 48 kHz may be transmitted from a point (8/20)T after a transmission time point. Therefore, a corresponding value needs to be compensated for a time of flight (TOF) value based on a transmission start point.

Accordingly, as shown in FIG. 3, the signal processor 300 may further include a TOF compensator 320.

The TOF compensator 320 may calculate a TOF compensation value based on Δt, which is a difference between a time when a specific frequency occurs in the pulse train and a time when the specific frequency is measured in the reflected wave, and perform compensation on the cross-correlation signal based on the calculated TOF compensation value.

The TOF compensation may be required for the medium distance region.

In detail, the TOF compensation value may be calculated as in Equation 5 below:

$$\\ \begin{matrix}\frac{Δ t}{Magnitude of entire band of transmission frequency} \times T & [ Equation 5 ]\end{matrix}$$

(Here, T indicates a magnitude of the pulse train).

FIGS. 5A and 5B are the simulation graphs showing a vertical beam angle of a general chirp signal within a range of 40 kHz to 60 kHz and a vertical beam angle of a chirp signal within a range of 40 kHz to 60 kHz according to the present disclosure.

Unlike a case of using the general chirp beam angle of FIG. 5A, the same result as shown in FIG. 5B may be acquired when using the chirp beam angle according to the present disclosure.

In detail, FIG. 5B shows that the ultra sensor of the present disclosure provides the large beam angle for the near field, the small beam angle for the medium distance, and a beam angle entirely covering the far field.

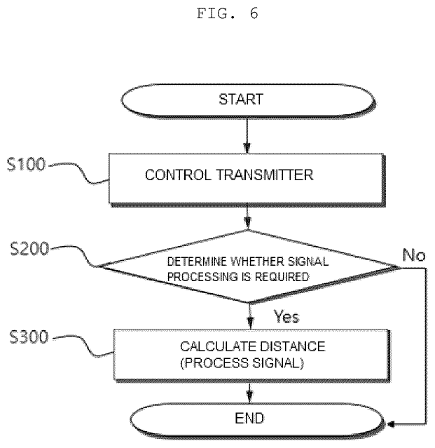

FIG. 6 is a flowchart showing a signal processing method of an ultrasonic sensor according to another embodiment of the present disclosure.

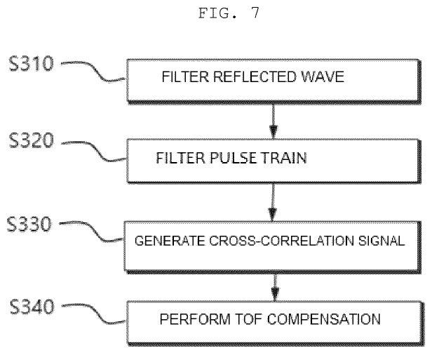

FIG. 7 is a flowchart showing a signal processing operation in another implementation example of another embodiment of the present disclosure.

Referring to FIG. 6, the present disclosure relates to a control method of an ultrasonic sensor 1000 including a transmitter 100, a receiver 200, and a signal processor 300, and the method may include (a) controlling the transmitter 100 by the signal processor 300 for the transmitter 100 to transmit a pulse train whose frequency is changed based on time (S100); and (b) calculating, by the signal processor 300, each distance to an object positioned in each of a plurality of predetermined regions by using a reflected wave received from the receiver 200 (S300).

In detail, the method may further include (a-1) determining whether signal processing by the ultrasonic sensor is required for the reflected wave based on a predetermined determination criterion (S200) after the operation (a) and before the operation (b).

In more detail, in the operation (a-1), when t indicates reception time of receiving the reflected wave, it may be determined that the signal processing by the ultrasonic sensor 1000 is required in a case where t is less than a predetermined maximum reception time. On the other hand, it may be determined that the signal processing by the ultrasonic sensor 1000 is not required when t is greater than the predetermined maximum reception time.

The operation (b) may be performed when it is determined that the signal processing is required in the operation (a-1).

The operation (b) according to another embodiment of the present disclosure may include: (b-1) performing filtering by passing only the reflected wave in a predetermined frequency band and changing a frequency band to be filtered by a band pass filter (BPF) based on the reception time of the reflected wave (S310); and (b-2) filtering the pulse train in the same frequency band as that of the reflected wave (S320).

In detail, in the operation (b-1), a time region of zero or more and less than T₁ may correspond to a near-field region of less than 60 cm, which requires a large beam angle to detect a road bump. Therefore, a low frequency band may be used in the region corresponding to T₁.

The T₁ may be 3.5 ms, and the low frequency band may be 40 kHz or more and less than 48 KHz.

In addition, a time region of T₁ or more and T₂ or less may correspond to a medium-distance region of 60 cm or more and 120 cm or less, which requires a small beam angle to distinguish a ground waveform from an obstacle. Therefore, a high frequency band may be used in the region corresponding to T₂.

The T₂ may be 7 ms, and the high frequency band may be 48 KHz or more and less than 60 KHz.

In addition, a region exceeding T₂ may correspond to a far-field region exceeding 120 cm, which requires an entire frequency band to detect a small reflected wave. Therefore, the entire frequency band may be used in the region corresponding to T₃.

The entire frequency band may be 40 kHz or more and 60 kHz or less.

As a result, when the beam angle is changed based on the time (or the distance) as described above, the large beam angle may be provided because the result of transmitting and receiving a signal of the low frequency is processed in the near field, and the small beam angle may be provided by using the high frequency band in the medium distance. In addition, a ground region may be already included in the beam angle in the far field, and the detection distance may thus be increased by even a small reflected wave detected using the entire signal band.

Meanwhile, in the operation (a), intermittent pulse group signals of the pulse train may be transmitted, and each of the pulse groups may be controlled to be transmitted by being changed to the frequency band of 40 kMz or more and 60 kMz or less based on the time.

In addition, the operation (b) may further include (b-3) generating a cross-correlation signal by cross-correlating the filtered pulse train and the reflected wave after the operation (b-2).

According to another implementation example of another embodiment of the present disclosure as shown in FIG. 7, the operation (b) may further include (b-4) calculating a time of flight (TOF) compensation value based on Δt, which is a difference between a time when a specific frequency occurs in the pulse train and a time when the specific frequency is measured in the reflected wave, and performing compensation on the cross-correlation signal based on the calculated TOF compensation value (S340), after the operation (b-3).

As set forth above, in the Chirp-based ultrasonic sensor and the signal processing method according to the various embodiments of the present disclosure, the ultrasonic sensor may change the beam angle, and one ultrasonic sensor may thus detect the near field, the medium distance, and the far field.

In addition, in the present disclosure, two types of sensors used to be mounted on similar positions may be integrated with each other, thereby lowering a cost of a corresponding system, and all ultrasonic sensors mounted on the vehicle may detect the near field, the medium distance and the far field detection, thereby improving performance of an autonomous parking system.

Although the embodiments of the present disclosure are described as above, the embodiments disclosed in the present disclosure are provided not to limit the spirit of the present disclosure, but to describe the present disclosure. Therefore, the spirit of the present disclosure may include not only each disclosed embodiment, but also a combination of the disclosed embodiments. Further, the scope of the present disclosure is not limited by these embodiments. In addition, it is apparent to those skilled in the art to which the present disclosure pertains that a variety of variations and modifications could be made without departing from the scope of the present disclosure as defined by the appended claims, and all such appropriate variations and modifications should also be understood to fall within the scope of the present disclosure as equivalents.

What is claimed is:

1. An ultrasonic sensor which measures a distance to an object, the sensor comprising:
a transmitter outputting an ultrasonic signal;
a receiver receiving a reflected wave of the output ultrasonic signal as reflected by the object; and
a signal processor providing an ultrasonic signal command to be output to the transmitter and calculating the distance to the object by using the reflected wave received by the receiver,
wherein the signal processor controls the transmitter to transmit the ultrasonic signal as a pulse train having a frequency changed based on time.

2. The sensor of claim 1, wherein the signal processor calculates each distance to an object reflecting the output ultrasonic signal positioned in any of a plurality of predetermined regions.

3. The sensor of claim 2, wherein the signal processor calculates each distance to an object positioned in at least one of a near field, a medium distance, and a far field.

4. The sensor of claim 1, wherein:
the signal processor includes a first band pass filter (BPF) passing only the reflected wave in a predetermined frequency band, and
the first BPF performs filtering by changing a frequency band to be filtered by the first BPF based on reception time of the reflected wave.

5. The sensor of claim 4, wherein the signal processor passes:
a frequency only in a range of 40 to 48 kHz when a reception time of the reflected wave is zero to T₁, a frequency only in a range of 48 to 60 kHz when the reception time of the reflected wave is T₁ to T₂, and a frequency in a range of 40 to 60 kHz when the reception time of the reflected wave is greater than T₂.

6. The sensor of claim 1, wherein the signal processor:
transmits intermittent pulse group signals of the pulse train, and
controls each of the pulse groups to be changed to a frequency band of 40 to 60 kHz based on the time.

7. The sensor of claim 1, wherein the signal processor includes a signal generator generating a cross-correlation signal to cross-correlate the ultrasonic signal and the reflected wave.

8. The sensor of claim 7, wherein the signal processor further includes a second band pass filter (BPF) passing only the ultrasonic signal in a predetermined frequency band, and the predetermined frequency band is in common with a frequency band of the reflected wave.

9. The sensor of claim 7, wherein the signal processor further includes a time of flight (TOF) compensator calculating a TOF compensation value based on Δt, which is a difference between a time when a specific frequency occurs in the ultrasonic signal and a time when the specific frequency is measured in the reflected wave and performing TOF compensation on the cross-correlation signal.

10. A signal processing method of an ultrasonic sensor which includes a transmitter, a receiver, and a signal processor, the method comprising:
(a) controlling the transmitter by the signal processor for the transmitter to transmit a pulse train having a frequency that is changed based on time; and
(b) calculating, by the signal processor, a distance to any object positioned in each of a plurality of predetermined regions by using a reflected wave received from the receiver.

11. The method of claim 10, further comprising determining whether signal processing by the ultrasonic sensor is performed for the reflected wave based on a predetermined criterion before calculating distance.

12. The method of claim 11, wherein t is reception time of receiving the reflected wave, the method further comprising:
when t is less than a predetermined maximum reception time, determining that the signal processing by the ultrasonic sensor is performed before calculating distance, and
when t is greater than the predetermined maximum reception time, determining that the signal processing by the ultrasonic sensor is not performed before calculating distance.

13. The method of claim 12, calculating a distance to an object positioned in at least one of a near field, a medium distance, and a far field.

14. The method of claim 10, wherein calculating a distance includes:
with a band pass filter (BPF), performing filtering of the reflected wave by passing only a predetermined frequency band and changing a frequency band to be filtered by the band pass filter (BPF) based on reception time of the reflected wave; and
filtering the pulse train with a common frequency band as that of the reflected wave.

15. The method of claim 14, wherein the BPF is controlled to pass:
a frequency only in a range of 40 to 48 kHz when the reception time of the reflected wave is zero to T₁, a frequency only in a range of 48 to 60 kHz when the reception time of the reflected wave is T₁ to T₂, and a frequency in a range of 40 to 60 kHz when the reception time of the reflected wave is greater than T₂.

16. The method of claim 10, wherein:
controlling the transmitter by the signal processor for the transmitter to transmit a pulse train comprises transmitting intermittent pulse group signals of the pulse train, and
controlling each of the pulse groups to be transmitted by being changed to a frequency band of 40 to 60 kMz based on the time.

17. The method of claim 14, further comprising, generating a cross-correlation signal by cross-correlating the filtered pulse train and the reflected wave.

18. The method of claim 17, further comprising:
calculating a time of flight (TOF) compensation value based on Δt, which is a difference between a time when a specific frequency occurs in the pulse train and a time when the specific frequency is measured in the reflected wave, and
performing TOF compensation on the cross-correlation signal.
